(19) United States
(12) Patent Application Publication
(10) Pub. No.: US 2017/0256180 A1
(43) Pub. Date: Sep. 7, 2017

(54) TACTILE SOCKET LOCATING OUTLET COVER

(71) Applicant: Eric C. Ritter, Hauppauge, NY (US)

(72) Inventor: Eric C. Ritter, Hauppauge, NY (US)

(21) Appl. No.: 15/057,852

(22) Filed: Mar. 1, 2016

(51) Int. Cl. G09B 21/00; H02G 3/14

(52) U.S. Cl. CPC G09B 21/003; H02G 3/14

(57) ABSTRACT

A tactile socket outlet cover which has a faceplate, a locating area, and a locating track, which locating track is used for guiding a user in a tactile manner from the locating track to the socket of the outlet. The locating area or areas are attached to the faceplate at either or both of its top and bottom edge, and the locating tracks extend from the distal edges of the locating areas to the precipice of a hole of the faceplate for accommodating the receptacle of the outlet.

### BACKGROUND OF THE INVENTION

### Field of the Invention

The present invention relates to an outlet locators, and more particularly, a tactile socket locating outlet cover.

Description of the Prior Art

Numerous innovations for socket accessories have been provided in the prior art that will be described. Even though these innovations may be suitable for the specific individual purposes to which they address, however, they differ from the present invention.

A FIRST EXAMPLE, U.S. Pat No. 3,199,063, Published/Issued on Aug. 3, 1965, to Stuart teaches a fiush cover plate adapted for the alternative attachment to the back thereof of an outlet socket connector or other accessory, the said cover plate being formed with a hole to expose the forward end of the accessory and with means for cating engagement with said accessory in any one of a plurality of alternative angular positions thereof.

A SECOND EXAMPLE, U.S. Pat. No. 3,909,101, Published/Issued on Sep. 30, 1975, to Bruels teaches an apparatus for conducting a flexible conduit such as an electrical, pneumatic or hydraulic conductor from an outlet in a flat surface such as a wall, comprising mounting plate means through which segments of lead conduit may be threaded, cover plate means for mating with said mounting plate means, means located on said cover plate means for locating and supporting connections between the segments of lead conduit and a segment of outlet conduit and interacting means located on said mounting and cover plate means for clamping said segment of outlet conduit and providing an aperture for threading the segment of outlet conduit exteriorly of the mounting and cover plate means, whereby an extended portion of the segment of outlet conduit may be attached to a suitable plug or connector to provide a flexible outlet.

A THIRD EXAMPLE, U.S. Pat. No. 6,722,911, Published/Issued on Apr. 20, 2004, to Ye teaches an electrical connector for electrically connecting an electronic package such as a central processing unit with a circuit substrate such as a printed circuit board. The electrical connector includes an insulative base (1), and a cover (2) slidably attached on the base. The cover includes a pair of opposite retention flanges (22). A pair of sliding slots (222) is defined in the flanges, and a pair of locating recesses (221) is defined in the flanges respectively adjacent the sliding slots. The base includes a pair of opposite sliding rails (1222), and a pair of locating protrusions (1221) formed respectively adjacent the sliding rails. When the cover is attached to the base, the sliding slots guide and receive the sliding rails therein, and the locating recesses retainingly receive the locating protrusions therein.

A FOURTH EXAMPLE, U.S. Pat. No. 7,445,472, Published/Issued on Nov. 4, 2008, to Huang, et al. teaches a safety electric socket in which two spring-supported doorplates are respectively pivoted to a holder block to block the neutral and hot slots against outside dust and water and to stop the spring-supported on/off switching button from downward movement. The doorplates are opened for allowing downward movement of the switching button to switch on power supply when the neutral and hot blades of an electric plug are respectively inserted into the neutral and hot slots.

A FIFTH EXAMPLE, U.S. Pat. No. 7,595,449, Published/Issued on Sep. 29, 2009, to Dyderski teaches an electrical outlet safety cover plate assembly for an electrical outlet receptacle having at least one socket, with apertures corresponding to those in the electrical outlet receptacle for receiving the male prongs of an electrical plug. The safety cover plate, and most of the assembly being made of non-conductive material. The safety cover plate includes a single shutter per outlet plug that is slidably mounted on the back surface of the safety cover plate and has apertures that correspond to the apertures in the safety cover plate. The shutter includes a member extending outward from the shutter in a direction opposite the biasing force acting upon the shutter. The protruding member extends out thru an access opening in the safety cover plate for manual positioning of the shutter. A biasing element acts upon the shutter to normally bias the shutter in the non-aligned position, thus effectively covering to the apertures of the electrical outlet receptacle. The protruding member of the shutter must be moved in a direction opposite the biasing force and away from the cover plate to align the apertures of the shutter with the apertures in the cover plate thus allowing for insertion of an electrical plug into the outlet receptacle. When the electrical plug is retracted the shutter is repositioned into the non-aligned position by the biasing element. A younger child would have a difficult time to position and hold the shutter so that an object could be inserted into the electrical outlet receptacle. It also allows for ease of use by an adult. The aforementioned safety cover plate is also more aesthetically appealing than those currently found in the market and it would hide the unsightly electrical outlet receptacles commonly found in most homes.

A SIXTH EXAMPLE, U.S. Pat. No. 7,690,942, Published/Issued on Apr. 6, 2010, to Berg, et al. teaches a receptacle that has the individual prong-holes identified and differentiated with light source or markings in a scheme that allows the user to quickly locate and identify the proper prong-holes. The associated plug can be labeled with markings for orientation. The receptacle lighting or pattern scheme will help the user easily locate the receptacle and orient the associated plug for accurate and rapid insertion.

A SEVENTH EXAMPLE, U.S. Pat. No. 8,105,107, Published/Issued on Jan. 31, 2012, to Gorman teaches an electrical box is mounted on a wall stud, and a wiring panel is installed within the electrical box so as to partition the interior of the electrical box into a user inaccessible wiring compartment and a user accessible module compartment. A protective cover is attached to the wiring panel so as to protect the wiring panel during a makeup phase of wall panel installation and painting. After the makeup phase, the protective cover is removed from the wiring panel and a module having a user operable electrical function is mounted to the wiring panel within the user accessible module compartment.

AN EIGHTH EXAMPLE, U.S. Pat. No. 8,388,371, Published/Issued on Mar. 5, 2013, to Gorman teaches an electrical box is mounted on a wall stud, and a wiring panel is installed within the electrical box so as to partition the interior of the electrical box into a user inaccessible wiring compartment and a user accessible module compartment. A protective cover is attached to the wiring panel so as to protect the wiring panel during a makeup phase of wall panel installation and painting. After the makeup phase, the protective cover is removed from the wiring panel and a module having a user operable electrical function is mounted to the wiring panel within the user accessible module compartment.

It is apparent low that numerous innovations for socket locators have been provided in the prior art that adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a tactile socket locating outlet cover that avoids the disadvantages of the prior art.

ANOTHER OBJECT of the present invention is to provide a tactile socket locating outlet cover that is simple and inexpensive to manufacture.

STILL ANOTHER OBJECT of the present invention is to provide a tactile socket locating outlet cover that is simple to use.

BRIEFLY STATED, STILL YET ANOTHER OBJECT of the present invention is to provide a tactile socket locating outlet cover that provides an effective guide towards a socket in an obstructed area, or for a person who is visually impaired.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic perspective view illustrating a first embodiment of the tactile socket locating outlet cover in use;

FIG. 2 is a front plan view, taken in the direction of arrow 2 in FIG. 1, of a first embodiment of a tactile socket locating outlet cover per se;

FIG. 3 is a similar front plan view, taken in the direction of arrow 2 in FIG. 1, of a second embodiment of a tactile socket locating outlet cover per se;

FIG. 4 is a cross sectional view taken on line 4-4 in FIG. 2;

FIG. 5 is a cross sectional view taken on line 5-5 in FIG. 2; and

FIG. 6 is a cross sectional view taken on line 6-6 in FIG. 2 showing a typical electrical plug cooperating with grooves in the cover.

### A MARSHALING OF REFERENCE NUMERALS UTILIZED IN THE DRAWING

10 tactile socket outlet cover
12 faceplate
14 locating area
16 locating track
17 outlet
18 socket
19 plug
20 top edge of faceplate 12
22 bottom edge of faceplate 12
24 height of faceplate 12 from wall 26
26 wall
28 height of locating area 14 from wall 26
30 border of locating area 14
32 height of locating track 16
34 distal edge of locating area
36 hole of faceplate 12 for accommodating receptacle 37 of outlet 17
37 receptacle of outlet 17
38 precipice of hole 36 of faceplate 12 for accommodating receptacle 37 of outlet 17
40 width of locating area 14
42 width of faceplate 12

### DETAILED DESCRIPTION OF THE PREFERRED EMBODIMENT

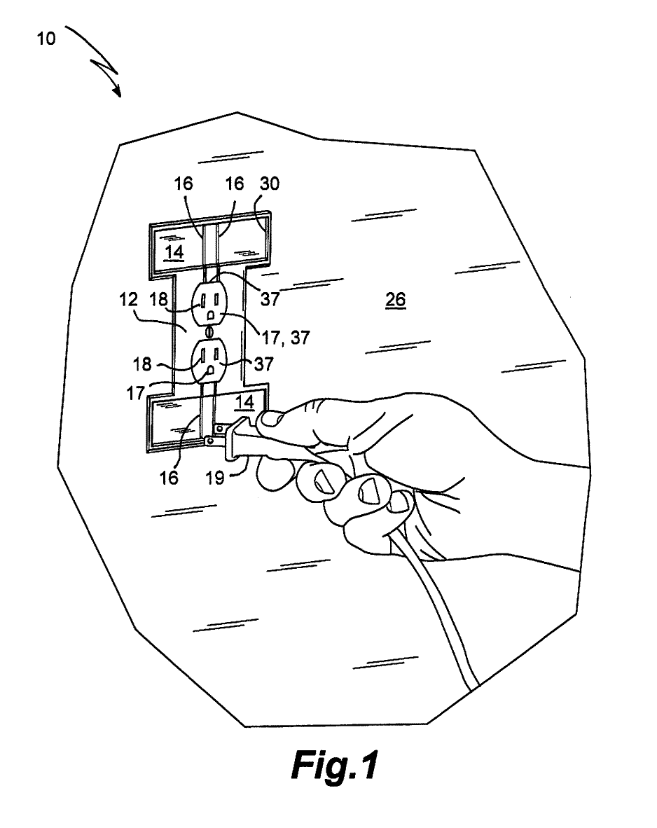

Referring now to the figures, in which like numerals indicate like parts, and particularly to FIG. 1, disclosed is a tactile socket locating outlet cover 10 which has:

a) a faceplate 12;

b) at least one locating area 14; and

c) at least one locating track 16.;

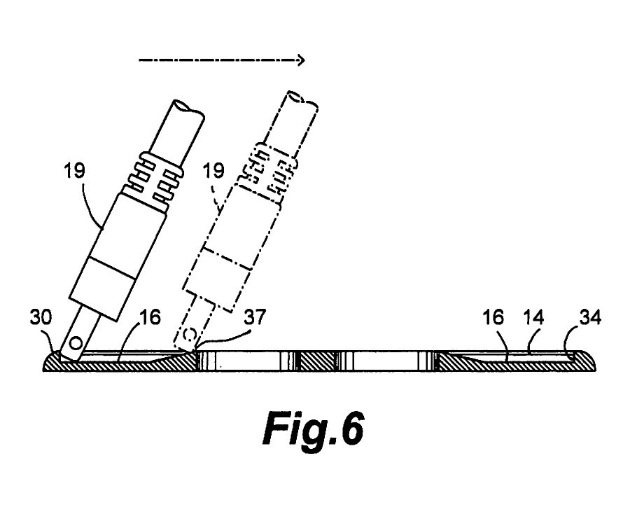

The faceplate is for being a cover for an outlet 17 on a wall 26 or the like. The at least one locating area 14 is proximally connected to the faceplate 12. The at least one locating track 16 is a track extending between the locating area 14 and the faceplate 12. In use, this allows a user to drag a plug 19 along the at least one locating track 16 to the outlet 17. Such a motion is illustrated in FIG. 6.

The outlet 17 covered by the faceplate 12 has at least one socket 18 therein. The at least one locating track 16 corresponds to the at least one socket 18 of the outlet 17 so that a user can trace from the at least one locating area 14 to the socket 18 of the at least one outlet 17 in said at least one locating track 16.

The faceplate 12 has a top edge 20 and a bottom edge 22. The at least one locating area 14 is proximally connected to the faceplate 12 along at least one of the top edge 20 and the bottom edge 22. Given the ordinary orientation of sockets 18 in North America being vertical slots (as illustrated in FIG. 1) this facilitates locating the sockets 18 in the correct orientation.

In the preferred embodiment the at least one locating track 16 constitutes at least two locating tracks 16. This corresponds with the ordinary layout of sockets 18 in North America. The at least two locating tracks 16 correspond to two sockets 18 of the outlet 17. The at least two locating tracks 16 are parallel. Although not illustrated, it would be possible to have three parallel locating tracks 16 for a standard three-prong outlet 17 in North America.

In order to facilitate location, a variety of heights are used to create a tactile sensation. The faceplate 12 has a height 24 from the wall 26. The at least one locating area 14 has a height 28 from the wall. The height 24 of the faceplate 12 is higher than the height 28 of the locating area.

To further create a tactile sensation, the locating area 14 has a border 30. The border 30 constitutes all edges of the locating area 14 which are not proximally connected to the faceplate 12. The border 30 is raised. In the preferred embodiment for ease of manufacture the border 30 of the locating area 14 is the same height 24 as the faceplate 12, as illustrated in FIG. 4.

Still further to creating effective tactile sensations, the at least one locating track 16 has a height 32 from the wall 26, which height 32 varies within the length of the at least one locating track 16. The at least one locating area 14 has a distal edge 34. The distal edge 34 of the locating area 14 is opposite the connection of the faceplate 12 to the locating area 14. The faceplate 12 has at least one hole 36 for accommodating a receptacle 37 of the outlet 17. The at least one locating track 16 extends from the border 30 of the locating area 14 on the distal edge 34 of the at least one locating area 14 to the precipice 38 of the at least one hole 36 for accommodating a receptacle 37 of the outlet 17. This configuration allows a user to trace a plug in a tactile manner along the border 30 until reaching the locating track 16 so that they can then trace it through the locating track 16 to the outlet 17.

As previously stated, the at least one locating track 16 varies in height 32 from the wall 26 along its length. To facilitate capture in the locating area 14, the height 32 from the wall 26 the at least one locating track 16 is lower than the height 28 from the wall 26 of the locating area 14 when the at least one locating track 16 is in the at least one locating area 14. As most clearly illustrated in FIG. 4, the height 32 of the at least one locating track 16 matches the height 28 of the faceplate 12 at the precipice 38 of the at least one hole 36 for accommodating a receptacle 37 of the outlet 17.

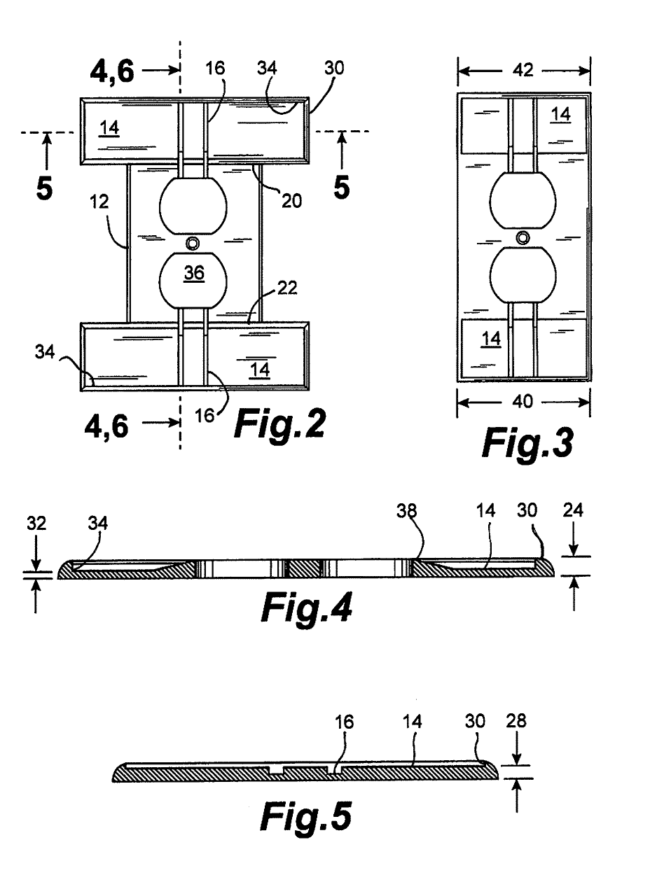

In the preferred embodiment and as illustrated in FIGS. 2 and 3, the at least one locating area 14 constitutes two locating areas 14. The at least two locating tracks 16 constitute two pairs of locating tracks 16. The two locating areas 14 are located on each of the top edge 20 of the faceplate 12 and the bottom edge 22 of the faceplate 12.

Two embodiments are shown in FIGS. 2 and 3 respectively. In the first embodiment, shown in FIG. 2, the locating areas 14 have widths 40. The faceplate 12 has a width 42, and the width 40 of the locating areas 14 is greater than the width 42 of the faceplate 12. The first embodiment is expected to provide greater tactile locating ability, but also takes more space on a wall. In the second embodiment, shown in FIG. 3, the locating areas 14 have widths 40. The faceplate 12 has a width 42, and the width 40 of the locating areas 14 is equal to the width 42 of the faceplate 12.

It will be understood that each of the elements described above, or two or more together, may also find a useful application in other types of constructions differing from the types described above.

While the invention has been illustrated and described as embodiments of a tactile socket locating outlet cover, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A tactile socket locating outlet cover which comprises:
a) A faceplate;
b) At least one depression comprising a locating area; and
c) At least one locating track;
wherein said faceplate is for being a cover for an outlet on a wall;
wherein said at least one depression comprising a locating area is proximally connected to said faceplate;
wherein said at least one locating track is a track extending between said depression comprising a locating area and said faceplate.

2. The cover of claim 1 wherein the outlet covered by said faceplate has at least one socket therein; and
wherein said at least one locating track corresponds to the at least one socket of said outlet so that a user can trace from said at least one depression comprising a locating area to the at least one socket of the at least one outlet in said at least one locating track.

3. The cover of claim 2 wherein said faceplate has a top edge and a bottom edge; and
wherein said at least one depression comprising a locating area is proximally connected to said faceplate along at least one of said top edge and said bottom edge.

4. The cover of claim 3 wherein said at least one locating track comprises at least two locating tracks;
wherein said at least two locating tracks correspond to two sockets of said outlet; and
wherein said at least two locating tracks are parallel.

5. The cover of claim 3 wherein said faceplate has a height from the wall;
wherein said at least one depression comprising a locating area has a height from the wall; and
wherein said height of said faceplate is higher than the height of said depression comprising a locating area;

6. The cover of claim 5 wherein the difference in height from the wall between said at least one depression comprising a locating area and said faceplate comprises a border;
wherein the border comprised of the difference in height between said depression comprising a locating are and said faceplate comprises the entirety of the length around said difference in height

7. The cover of claim 6 wherein the highest point of said border of said depression comprising a locating area is the same height as said faceplate; and
wherein the lowest point of said border of said depression comprising a locating area is the same height of said depression comprising a locating area.

8. The cover of claim 7 wherein said at least one locating track has a height from the wall; and
wherein said height varies within the length of said at least one locating track;

9. The cover of claim 8 wherein said at least one depression comprising a locating area has a distal edge;
wherein said distal edge of said depression comprising a locating area is opposite the connection of the faceplate to the locating area;
wherein said faceplate has at least one hole for accommodating a receptacle of the outlet; and
wherein said at least one locating track extends from said border of said depression compromising a locating area on said distal edge of said at least one depression comprising a locating area to the precipice of said at least one hole for accommodating a receptacle of the outlet.

10. The cover of claim 9 wherein said at least one locating track varies in height from the wall along its length;
wherein said height from the wall of said at least one locating track is lower than the height from the wall of said depression comprising a locating area when said at least one locating track is in said depression comprising a locating area; and
wherein said height of said at least one locating track matches the height of said faceplate at the precipice of said at least one hole for accommodating a receptacle of the outlet.

11. The cover of claim 4 wherein said at least one depression comprising a locating area comprises two locating areas;
wherein said at least two locating tracks comprise two pairs of locating tracks; and
wherein said two depressions comprising locating areas are located on each of said top edge of said faceplate and said bottom edge of said faceplate.

12. The cover of claim 11 wherein said depressions comprising locating areas have widths;
wherein said faceplate has a width; and
wherein said width of said depressions comprising locating areas is less than the width of said faceplate.

13. (canceled)
